(19) United States
(12) Patent Application Publication
(10) Pub. No.: US 2014/0316538 A1
(43) Pub. Date: Oct. 23, 2014

(54) ASSISTANCE SYSTEM

(71) Applicants: Juergen Rataj, Meinersen (DE); Friedrich Faubel, Saarbruecken (DE); Hartmut Helmke, Braunschweig (DE); Dietrich Klakow, Saarbruecken (DE)

(72) Inventors: Juergen Rataj, Meinersen (DE); Friedrich Faubel, Saarbruecken (DE); Hartmut Helmke, Braunschweig (DE); Dietrich Klakow, Saarbruecken (DE)

(73) Assignees: UNIVERSITAET DES SAARLANDES, Saarbruecken (DE); DEUTSCHES ZENTRUM FUER LUFT- UND RAUMFAHRT E.V., Koeln (DE)

(21) Appl. No.: 14/233,399

(22) PCT Filed: Jul. 19, 2012
(86) PCT No.: PCT/EP2012/064186

§ 371 Date: Jun. 17, 2014

Related U.S. Application Data
(60) Provisional application No. 61/607,167, filed on Mar. 6, 2012.

(30) Foreign Application Priority Data
Jul. 19, 2011 (DE) 10 2011 107 934.7

(51) Int. Cl. G05B 15/02

(52) U.S. Cl. CPC G05B 15/02
USPC 700/12

(57) ABSTRACT

The invention relates to an assistance system (1, 25) for providing support in situation-dependent planning and/or guidance tasks of a controlled system (2), comprising a state detection unit (3) for detecting at least one state (5, 5a) of the controlled system (2), an acoustic receiving unit (9, 27), which is designed to receive acoustic voice signals of voice communication (24) between at least two persons (21, 22), and a voice processing unit (7), which is designed to detect voice information (10) regarding the controlled system (2) from the received acoustic voice signals, wherein the state detection unit (3) is designed to adapt the detected state (5) and/or a predicted state (5a) of the controlled system (2) that can be derived from the current state, according to the detected voice information (10).

The invention relates to an assistance system for support in situation-dependent planning and/or management tasks of a controlled system comprising a state detection unit for detecting at least one state of the controlled system. The invention likewise relates to a method for support in situation-dependent planning and/or management tasks of a controlled system with detection of at least one state of the controlled system. The invention likewise relates to a computer program for this.

Owing to the further-increasing degree of automation in virtually all spheres of life, ever increasing use is made of assistance systems which are intended to support wholly or only in subregions or even completely take over the planning and/or management tasks in order to unburden people responsible for the planning and/or management task and to increase safety.

In most cases, the assistance systems are set up in such a way that one or more states in relation to the controlled system are detected by detecting features of the controlled system, such as, for example, parameters of the controlled system, measured values, objects and/or environmental features. In this regard, the assistance systems are connected to a series of sensor systems or databases, from which the information items necessary for the detection of the state can be accessed. As a result, the assistance system can establish a machine-based situation awareness in order to then derive from this corresponding support measures for the relevant people, for example on the basis of strategies and targets, or in order to be able to implement fully automated closed-loop control.

It is often the case for such control loops that people responsible for the planning and/or management task issue action instructions which only have an effect on the controlled system with a time delay, with the result that the downstream assistance systems which, with the aid of their connected sensor system, attempt to detect the present state of the controlled system likewise detect such a change with a time delay. In the meantime, however, the assistance systems issue action recommendations to the people which are based on old information items relating to the state of the controlled system, with the result that rejection by such assistance systems is more likely. If the intention is for the assistance systems to take over action tasks independently at least partially as well, this can sometimes have serious consequences if a change in situation is not identified and also factored in good time. In particular in the case of controlled systems in which intervention by people can also take place externally, there is a particular risk here.

### PRIOR ART

DE 10 2009 034 069 A1 discloses an operating apparatus for a motor vehicle which has a display for displaying changing information items. With the aid of a viewing direction identification unit, the viewing direction of the motor vehicle driver can be determined, wherein the operating apparatus can be operated with the aid of acoustic commands when the viewing direction of the motor vehicle driver is directed at the display.

### Problem

The problem of the present invention consists in providing an improved assistance system for support in situation-dependent planning and/or management tasks of a controlled system which can respond quickly to changing states or situations of the controlled system without additionally burdening the operating personnel.

### Solution

The problem is solved according to the invention by the assistance system mentioned at the outset in that an acoustic recording unit, which is designed to record acoustic voice signals of a voice communication between at least two people, and a voice processing unit, which is set up to identify voice information items in relation to the controlled system from the recorded acoustic voice signals, are provided, wherein the state detection unit is set up to match the detected state and/or a predicted state, derivable from the present state, of the controlled system depending on the identified voice information items, and wherein a voice hypothesis unit is provided, which is designed to determine voice hypotheses in relation to voice information items expected in the future depending on the detected state and/or a predicted state, derivable from the present state, wherein the voice processing unit is set up to identify the voice information items in relation to the controlled system from the recorded acoustic voice signals taking into consideration the determined voice hypotheses.

The core concept of the present invention consists in that the assistance system, with the aid of an acoustic recording unit, records acoustic voice signals of a voice communication between two people, in particular two people which can have an effect on the controlled system, and analyzes these voice signals with the aid of a voice processing unit which uses voice hypotheses and compares said voice signals with the self-developed hypotheses. In the process, corresponding voice information items in relation to the controlled system can be identified from the recorded acoustic voice signals, with the result that the detected state and/or a predicted state, derivable from the present state of the controlled system, in particular by means of planning, can be matched depending on the identified voice information items. The comparison of the future situation hypotheses developed by the machine with the action instructions identified by voice identification for the future situation can be used for matching the strategies and targets in the assistance system to those of the operator.

Thus, the assistance system can respond substantially more quickly to changing situations or states without needing to run the risk in the process of entering the “out-of-the-loop” state. The assistance system can thus respond more effectively to future changing states, for example on the basis of instructions from an operator without any physical changes at this time, even if nothing has yet taken place in the real world following the instruction to the air traffic controller. Without corresponding procedures having been introduced, there is therefore anticipation of the physically predicted.

This is because, by virtue of the voice communication between people involved in the working process of the controlled system being listened to, prematurely induced changes of state on the controlled system can be identified, with the result that the detected and the expected state can be matched to one another correspondingly early. The action recommendations derived from the assistance system in relation to the controlled system are matched substantially more accurately and substantially better to the situation owing to the early matching of the state or of a predicted state, with the result that the quality of support of such assistance systems is considerably improved. The situation of the controlled system therefore relates to a state expected in the future.

In order to further increase the identification rate of the voice identification, voice hypotheses relating to voice information items to be expected in the future are determined by means of a voice hypothesis unit depending on the detected or predicted state of the controlled system. By virtue of the determination of hypotheses in relation to future voice information items, the identification of the voice information items depending on these hypotheses can then be implemented. The voice context derived from the detected or predicted state can therefore be extended by hypotheses relating to future voice information items or voice context, which has a very positive effect on the identification rate.

It is very particularly advantageous now if, in addition, probabilities of occurrence are assigned to the determined voice hypotheses, and these probabilities predict the occurrence of these hypotheses with a certain degree of probability. In this case, the hypotheses represent a possibility, on the basis of the present or predicted state, for the occurrence of certain voice information items which could result with a certain degree of probability for the detected situation.

By virtue of the voice hypotheses and the probabilities of occurrence assigned to the voice hypotheses, in this case the accuracy of the voice identification can be significantly increased since now the voice identification can be directed to the significant component in relation to the context of the detected situation.

The detection of at least one state of the controlled system by the state detection unit can be performed by a first sensor system which is connected to the state detection unit; such sensor systems are generally used for monitoring controlled systems, such as, for example, radar sensors, tracking units, temperature sensors, etc. Then, the present state of the controlled system can be detected from the detected data from the sensor system. With knowledge of the present state of the controlled system, possibly in conjunction with knowledge of targets to be achieved, furthermore also a predicted state for the future can be derived, which gives a prediction for the development of the states of the controlled system. It is thus possible to derive how a state will develop in the future.

In this case, the acoustic voice signals do not represent a direct instruction in the form of device operation to the assistance system, but are part of a voice communication between two people. By virtue of the assistance system being listened to silently during the voice communication, it is not necessary for the relevant people to prepare the assistance system for a voice input. As a result, the people are clearly unburdened in the planning and/or management task. The acoustic recording unit in conjunction with the voice processing unit thus form a further, second sensor system for the detection or prediction of the state of the controlled system. The invention is thus characterized in that the acoustic recording unit and the voice processing unit are provided as a second sensor system.

Advantageously, the identification of the voice information items by the voice processing unit from the recorded acoustic voice signals takes place depending on a context, which can be determined from the detected or predicted state. Since the assistance system provides the context for the identification of voice information items, the identification rate in the voice identification can thus be significantly increased, in particular when a context-based voice identification is used. The context of the detected state can in this case be derived from the hypotheses of the assistance system by the use of existing situation knowledge of the controlled system using the sensor data and databases.

In an advantageous embodiment, the assistance system is set up in such a way that the recording unit is set up to receive electrical signals of an electrical voice communication link and to record the acoustic voice signals from the received electrical signals. This is advantageous in particular when the communication between the people is performed via an electrical voice communication link, for example via radio or via a telephone network.

Furthermore, in a further advantageous configuration, the assistance system has an output unit, which is set up to output generated support instructions for supporting the situation-dependent planning and/or management task of the controlled system, wherein the support instructions can be derived from the detected or predicted state. Such an output unit can be, for example, a display on which action instructions for a person are displayed. The output unit can, however, also be connected to a control device in order to be able to have direct access to manipulated variables of the controlled system and thus to be able to act on the controlled system at least partially autonomously, as a result of which at least partially automatic operation is made possible.

In a further advantageous embodiment, the assistance system determines action options for supporting the situation-dependent planning and/or management task of the controlled system, for example in the form of support instructions. These action options are determined on the basis of the detected state and/or the predicted state, derivable from the present state, of the controlled system and thus predetermine possible action options for acting on the controlled system. In this case, the action options result in different predicted states and therefore interact with one another. Then, with the aid of the voice hypothesis unit, voice hypotheses in relation to voice information items to be expected in the future can be determined from these action options, with the result that the voice identification intended to be used to determine voice information items for matching the detected or predicted state are improved since action options determined from the state are now used as the basis for the voice hypotheses. In this case, the voice identification can be increased from previously 75% identification rate to up to 95%.

In this case, it is now very particularly advantageous if, in addition, the action options are determined from the already identified voice information items, as a result of which now only the action options which are probable in relation to the voice information items need to be taken into consideration. This is because, owing to the known voice information items, the state in relation to the controlled system is matched, as a result of which action options which are now improbable or no longer make any sense can remain out of the equation.

As a result, it is possible not only for the voice identification to be improved, but also for the acceptance of such assistance systems to be improved since the provided action options are matched substantially more accurately to the state of the controlled system.

This is a preferably interactive procedure, in which various hypotheses relating to a future situation are generated. Owing to the voice identification, it is known to the system which hypothesis is implemented by the air traffic controller. Thereupon, the system can establish improved plans for the future.

Moreover, the problem is also solved by the method as claimed in claim 8. Advantageous configurations of the method can be gleaned from the corresponding dependent claims.

The invention will be explained in more detail by way of example with reference to the attached drawings, in which:

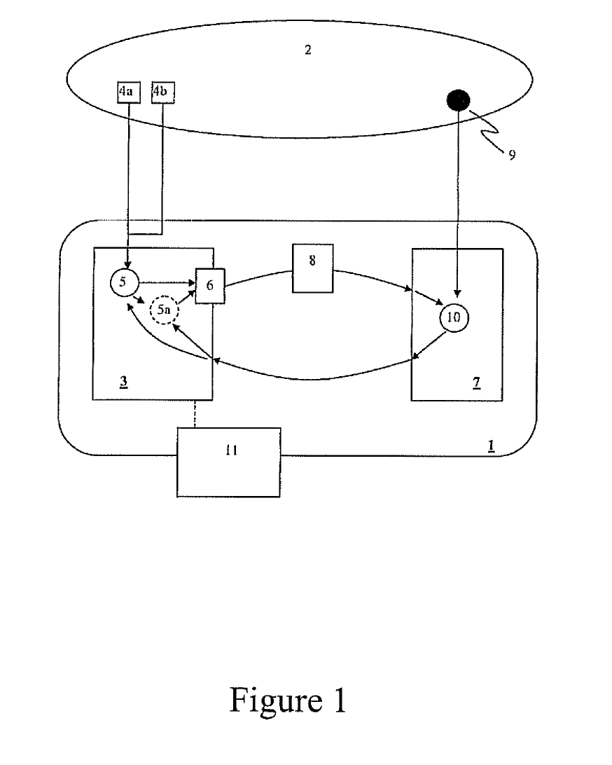

FIG. 1 shows a schematic illustration of the assistance system according to the invention;

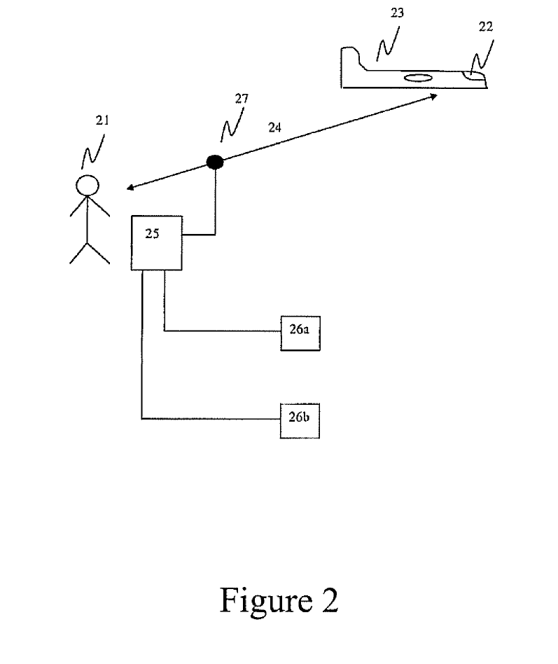

FIG. 2 shows a schematic illustration of the closed-loop control sequence for air traffic controller support.

FIG. 1 shows a schematic of the assistance system 1 according to the invention which can be used for support for planning and/or management tasks of a controlled system 2. A controlled system 2 can be, for example, the landing approach of aircraft at an airport which is generally monitored and regulated by air traffic controllers.

The assistance system 1 has a state detection unit 3, which, with the aid of sensors 4a, 4b, detects data relating to the controlled system 2 and from such data determines a present state 5 of the controlled system 2. A predicted state 5a relating to predetermined targets by the planning component of the assistance system can be derived from this present state 5 of the controlled system 2, and this predicted state takes into consideration a future development of the state 5 of the controlled system 2.

Both the present state 5 and a possibly derived and predicted state 5a are used in a context determination unit 6 as the basis for the determination of a voice context which is provided as an input to the voice identifier or the voice processing unit 7. This is because, owing to the knowledge of the present state 5 or a predicted state 5a, which can ultimately be derived from the sensor data of the controlled system 2 and from the action planning of the assistance system (hypothesis unit), the state detection unit thus ultimately also has available the context which is intended to be used by the voice identifier 7 as the basis for the voice identification. As a result, the accuracy in the identification can be substantially increased.

Furthermore, in addition, a voice hypothesis unit 8 can be provided which can determine voice hypotheses in relation to future voice information items which may occur from the present state 5 or predicted state 5a. In this case, the voice hypothesis unit 8 can be part of the state detection unit 3 or the voice processing unit 7. The voice context determined by the context determination unit 6 can thus be extended by the voice hypotheses of the hypothesis unit 8.

Both the voice context determined by the context determination unit 6 and the voice hypotheses are transmitted and fed to the voice processing unit 7 via an input thereof. Furthermore, the assistance system 1 is connected to an acoustic recording unit 9, which is likewise connected in terms of signals to an input of the voice processing unit 7. The acoustic recording unit 9 is in this case set up in such a way that it records acoustic voice signals in a voice communication between at least two people (not illustrated), as a result of which the acoustic recording unit 9 represents a further sensor or a further sensor system for state detection of the controlled system 2. The acoustic recording unit 9 can in this case in a simplest case be a microphone, which listens to the communication between two or more people. However, the acoustic recording unit 9 can also be an electrical apparatus with which voice signals can be tapped off from an electrical signal, as is present, for example, in the case of a radio link or a telephone link. Therefore, it is also possible to listen to communications between people communicating with one another via a telephone.

The voice signals recorded by the acoustic recording unit 9 are now analyzed by the voice processing unit 7 taking into consideration the determined voice context and the determined voice hypotheses and the voice information items 10 contained in the acoustic signals are identified. Owing to the fact that the context for the voice identification is directly or indirectly derivable from the controlled system, the planning (hypothesis unit) and the detected states 5, 5a, the voice identification of the detected acoustic voice signals can be substantially increased. With this context-based voice identification, not only the present voice signal but also the context which comes from an external source are used for the voice identification. Although this is more involved, it is also more efficient since, as a result, the search space is restricted either in rule-based or probabilistic fashion. Since the detected state comprises a large number of data and parameters relating to the controlled system 2, in this case the context required for the voice identification can be derived.

Thus, advantageously now only a small proportion of the context is determined by the voice identifier itself, while the substantial proportion of the context information relating to the state detection unit is determined from the state and the predicted states, i.e. the hypotheses relating to the future situations. The entire context is thus derived from the system state and the dialog between two communication partners. This redundant determination of the voice context makes it possible for the voice identifier to reject false identification hypotheses which are inconsistent with the context information at an early point in time and therefore to avoid erroneous identifications, as a result of which ultimately the identification performance is substantially increased.

The entire context is therefore firstly determined via a first sensor and planning system, which detects and predicts the system state of the controlled system, and via a second sensor system, which detects the voice communication between two communication partners, which substantially improves the voice identification itself.

The thus identified voice information items are now again transmitted back to the state detection unit 3, wherein, depending on the identified voice information items 10, the present state 5 or the predicted state 5a is matched depending on these voice information items 10. Since, for example, it has been identified from the conversations between the people that changes are intended to be implemented within the controlled system, with the result that the state will change, wherein this change in state is as yet undetectable by the sensor system 4a, 4b, the present state 5 or the predicted state 5a for the future can already be matched on the basis of the conversation, with the result that the assistance system has substantially more accurate information items relating to the controlled system 2 and therefore corresponding action recommendations which can be output at an output unit 11 are substantially more accurate.

Thus, the matching of the states 5, 5a by the state detection unit 3 can take place, by way of example, in such a way that certain parameters and/or data which describe the state of the controlled system 2 are changed, with the result that a changed state 5 or 5a is represented for the state detection unit 3, which changed state does not necessarily need to be consistent with the data sensed by the sensor system 4a, 4b, at least for a moment.

The assistance system can, in addition to the described units, have further units which provide, by way of example, certain regulations for the controlled system 2 or can output corresponding action information items or action recommendations via the output unit 11. An air traffic controller support system which is likewise intended to be embedded in the assistance system 1 and is intended to support the air traffic controller in his regulation and management task is mentioned here by way of example. By matching the detected states or predicted states of the controlled system 2, a substantially improved basis can be provided to the air traffic controller support system for its calculations and action recommendations, which increases acceptance and safety.

FIG. 2 shows such a system by way of example for the controlled system for the management of an aircraft by an air traffic controller 21. The air traffic controller 21 who is generally in the control center or in the tower of the airport is in radio communication with the pilot 22 of an aircraft 23. The air traffic controller 21 communicates corresponding instructions via the radio link 24 to the pilot 22 of the aircraft 23 in order that the pilot 22 can land the aircraft 23 on a predetermined trajectory at the airport.

For some time, to support the air traffic controller 21, so-called air traffic control support systems 25 have been known which can provide the air traffic controller with various suggestions for landing sequences and/or for air traffic management instructions for aircraft depending on the present situation in the air space of the airport. With the aid of sensors 26a, 26b, which may be, for example, radar sensors and therefore continuously provide radar data to the air traffic controller support system 25, a situation within the air traffic space or a state for the air traffic controller can be set up in order to allow for safe landing of the aircraft at the airport. However, these data also provide the air traffic controller support system 25 the basis for the suggestions of the landing sequences and/or management instructions to the aircraft.

If the air traffic controller 21 changes his strategy, however, the system 25 does not notice anything until clear indications are present and have been identified in the radar data in respect of a discrepancy in the flight characteristics. However, this can last up to 30 seconds or more, with the result that the displayed situation or the detected state relating to the controlled system and the suggestions provided by the system 25 are inconsistent with the actual situation or the actual state during this time. This lack of correspondence between the air traffic controller's intention and the machine-based situation awareness of the support system 25 results in restricted suggestions, however, which ultimately ensure a lack of acceptance of the system with the air traffic controllers.

In order to solve this problem, an acoustic recording unit 27 which is communicatively connected to the system 25 is located in the communication link 24 between the air traffic controller 21 and the pilot 22. The voice communication between the air traffic controller 21 and the pilot 22 via the communication link 24 is therefore tapped off with the aid of the acoustic recording unit 27 and made available to the system 25.

If flight management instructions which are now changed from the actual strategy are transmitted from the air traffic controller 21 to the pilot 22 via the communication link 24, this is detected by the acoustic recording unit 27. These voice instructions transmitted via the communication link 24 in this case represent the earliest possible time for identification of a change in strategy of the air traffic controller 21 in the air traffic control. By means of an assistance system as described in FIG. 1, which is part of the system 25, the voice information items in relation to the controlled system can be identified, wherein the states detected by the system 25 and the further predictions thereof on the basis of alternative plans implemented in the assistance system on the basis of various strategies provides the context for the voice identification. The voice information items identified via the communication link 24 of the relevant person 21 and 22 can then be used to match the states detected by the system 25 in order thus to be able to also take into consideration the change in strategy of the air traffic controller 21 when outputting corresponding proposals for air traffic management, although the changed states are not detectable until some time later via the radar sensors 26a, 26b. The air traffic controller first follows strategy 1, for example, and then changes over to strategy 2. This is identified because there are plans for both strategies. Since, however, not all possible plans are indicated by the system, only strategy 1 of the system needs to be identified externally for the air traffic controller, although more than one strategy is calculated.

The calculations of the system now change over to strategy 2 as the primary strategy which is output and processed in greater detail. Since there is a response to this change in plan by the air traffic controller directly by the system 25 by improving the dedicated plan, the air traffic controller is immediately given an impression of which further effects are initiated by the actions instructed by him. This is particularly helpful in situations with a high traffic volume since in such situations the burden is in any case high for the air traffic controller. By virtue of the increased confidence on the system side in respect of the expected development of the future situation, there is now additionally the possibility of indicating to the air traffic controller deviations by the aircraft from the planned trajectory. In this case, the matching of the situation by the air traffic controller takes place in such a way that said air traffic controller does not need to perform any further inputs to the system 25, such as, for example, by inputting corresponding instructions or by direct voice command. Instead, the matching is performed under circumstances of quite normal working processes for the air traffic controller 21. This represents a clear advantage of the system 25 over modern systems and the present system can already issue a warning at a time at which the previous system is still attempting to detect changes in strategy.

1. An assistance system for support in situation-dependent planning and/or management tasks of a controlled system comprising
a state detection unit for detecting at least one state of the controlled system,
an acoustic recording unit, which is designed for recording acoustic voice signals of a voice communication between at least two people, and
a voice processing unit, which is set up to identify voice information items in relation to the controlled system from the recorded acoustic voice signals,
wherein the state detection unit is set up to match the detected state and/or a projected state, derivable from the present state, of the controlled system depending on the identified voice information items, wherein a voice hypothesis unit is provided, which is designed to determine voice hypotheses in relation to voice information items expected in the future depending on the detected state and/or a predicted state, derivable from the present state, wherein the voice processing unit is set up to identify the voice information items in relation to the controlled system from the recorded acoustic voice signals taking into consideration the determined voice hypotheses.

2. The assistance system as claimed in claim 1, wherein the voice hypothesis unit is set up to assign probabilities of occurrence to the determined voice hypotheses, and the voice processing unit is set up to identify the voice information items further taking into consideration the probabilities of occurrence assigned to the voice hypotheses.

3. The assistance system as claimed in claim 1, wherein a context determination unit is provided, which is designed to determine a voice context depending on the detected state and/or a predicted state, derivable from the present state, wherein the voice processing unit is set up to identify the voice information items in relation to the controlled system from the recorded acoustic voice signals taking into consideration the determined voice context.

4. The assistance system as claimed in claim 1, wherein the acoustic recording unit is set up to receive electrical signals in an electrical voice communication link and to record the acoustic voice signals from the received electrical signals.

5. The assistance system as claimed in claim 1, wherein the assistance system has an output unit for outputting support instructions generated depending on the detected state and/or a predicted state, derivable from the present state, for supporting the situation-dependent planning and/or management task of the controlled system.

6. The assistance system as claimed in claim 1, wherein the assistance system is set up to determine action options for supporting the situation-dependent planning and/or management task of the controlled system depending on the detected state and/or a predicted state, derivable from the present state, of the controlled system, wherein the voice hypothesis unit is designed to determine the voice hypotheses in relation to voice information items expected in the future depending on action options determined from the detected state and/or the predicted state.

7. The assistance system as claimed in claim 6, wherein the assistance system is set up to determine action options for supporting the situation-dependent planning and/or management task of the controlled system further depending on the identified voice information items.

8. A method for support in situation-dependent planning and/or management tasks of a controlled system, comprising the following steps:
detection of at least one state of the controlled system by a state detection unit,
recording of acoustic voice signals of a voice communication between at least two people by an acoustic recording unit,
automatic identification of voice information items in relation to the controlled system from the recorded acoustic voice signals by a voice processing unit, and
matching of the detected state and/or a predicted state, derivable from the present state, of the controlled system depending on the identified voice information items by the state detection unit, characterized by
automated determination of voice hypotheses in relation to voice information items expected in the future depending on the detected state and/or a predicted state, derivable from the present state, by a voice hypothesis unit, and
automated identification of the voice information items in relation to the controlled system from the recorded acoustic voice signals taking into consideration the determined voice hypotheses by the voice processing unit.

9. The method as claimed in claim 8, characterized by assignment of probabilities of occurrence to the determined voice hypotheses by the voice hypothesis unit and identification of the voice information items further taking into consideration the probabilities of occurrence assigned to the voice hypotheses by the voice processing unit.

10. The method as claimed in claim 8, characterized by
automated determination of a voice context depending on the detected state and/or a predicted state, derivable from the present state, by a context determination unit, and
automated identification of the voice information items in relation to the controlled system from the recorded acoustic voice signals taking into consideration the determined voice context by the voice processing unit.

11. The method as claimed in claim 8, characterized by reception of electrical signals from an electrical voice communication link and recording of the acoustic voice signals from the received electrical signals by the recording unit.

12. The method as claimed in claim 8, characterized by determination of action options for supporting the situation-dependent planning and/or management task of the controlled system depending on the detected state and/or a predicted state, derivable from the present state, of the controlled system by the assistance system and determination of the voice hypotheses in relation to voice information items expected in the future depending on action options determined from the detected state and/or predicted state by the voice hypothesis unit.

13. The method as claimed in claim 12, characterized by determination of the action options for supporting the situation-dependent planning and/or management task of the controlled system further depending on the detected voice information items by the assistance system.

14. A computer program having program code means, in particular stored on a machine-readable carrier, set up to implement the method as claimed in one of claims 8 to 13 when the computer program is run on a computer.
